(19) United States
(12) Patent Application Publication
(10) Pub. No.: US 2022/0210693 A1
(43) Pub. Date: Jun. 30, 2022

(54) COMMUNICATION EQUIPMENT

(71) Applicant: NTT DOCOMO, INC., Tokyo (JP)

(72) Inventors: Teruaki Toeda, Tokyo (JP); Tooru Uchino, Tokyo (JP)

(73) Assignee: NTT DOCOMO, INC., Tokyo (JP)

(21) Appl. No.: 17/605,498

(22) PCT Filed: Apr. 26, 2019
(86) PCT No.: PCT/JP2019/017987

§ 371 Date: Oct. 21, 2021

(51) Int. Cl. H04W 28/04; H04L 1/18

(52) U.S. Cl. CPC H04W 28/04; H04L 1/188; H04L 1/1848

(57) ABSTRACT

A gNB-CU includes a transmitting unit that transmits a data unit of a protocol layer that handles packet data to a gNB-DU, a receiving unit that receives a data unit of the protocol layer from the gNB-DU, and a control unit that controls a discard timer of a data unit transmitted to the gNB-DU. The control unit determines an amount of delay between the gNB-CU and the gNB-DU and applies a timer value corresponding to the determined amount of delay to the discard timer.

### TECHNICAL FIELD

The present invention relates to a communication equipment that transmits and receives a data unit of a protocol layer that handles packet data.

### BACKGROUND ART

3rd Generation Partnership Project (3GPP) specifies Long Term Evolution (LTE), and with the aim of further speeding, specifies LTE-Advanced (hereinbelow, the LTE includes the LTE-Advanced). Moreover, in the 3GPP, further, specification of a succeeding system of the LTE called 5G, New Radio (NR), or Next Generation, and the like is being considered.

For instance, in specifications of 3GPP Release 16, adapting to Industrial IoT (IIoT) has been studied (Non-Patent Document1). In a case of adapting to IIoT, realization of ultra-reliable and low latency communications (URLLC: Ultra-Reliable and Low Latency Communications) is indispensable, and an improvement of efficiency of duplicate transmission control of a packet (data unit) in a packet data convergence protocol layer (PDCP) (PDCP duplication) securing high reliability has been included in the abovementioned study.

In specifications of 3GPP Release 15, it has been stipulated that, in a case in which a data unit (specifically, PDCP SDU (Service Data Unit)) discard timer is terminated, a node having PDCP entity (called as PDCP hosting node) instructs a node having an entity of a layer same as or lower than a radio link control layer (RLC), one by one to discard (Non-Patent Document 2).

Moreover, as the PDCP duplication is applied, since a frequency of such instruction becomes high, realizing improvement of efficiency while using the discard timer has been studied (Non-Patent Document 3).

### PRIOR ART DOCUMENT

### Non-Patent Document

Non-Patent Document 1: “New WID: Support of NR Industrial Internet of Things (IoT)”, RP-190728, 3GPP TSG RAN Meeting #83, 3GPP, March 2019
Non-Patent Document 2: 3GPP TS 38.425 V15.4.0, 3rd Generation Partnership Project; Technical Specification Group Radio Access Network; NG-RAN; NR user plane protocol (Release 15), 3GPP, December 2018
Non-Patent Document 3: “Way forward on the selective DL PDCP duplication for URLLC”, R3-192104, 3GPP TSG-RAN WG3 Meeting 190 103-bis, 3GPP, April 2019

### SUMMARY OF THE INVENTION

However, in a case of using the discard timer as mentioned above, there are limitations on the improvement of efficiency of the PDCP duplication.

Specifically, in a case in which the PDCP hosting node (for example, gNB-CU (Central Unit)) and the corresponding node (for example, gNB-DU (Distributed Unit) are separated, a propagation delay between the gNB-CU and the gNB-DU also occurs. Furthermore, it is common that time synchronization is not performed between the gNB-CU and the gNB-DU. Consequently, between the nodes, there is a possibility that a shift in acknowledgement of discard operation of the data unit occurs.

For example, there may occur cases in which a data unit that has been determined to be discarded by the termination of the discard timer is in fact transmitted to the UE, and conversely, a data unit that has been determined to have been transmitted is in fact discarded.

Therefore, the present invention has been made in view of the above discussion, and one object of the present invention is to provide a communication unit that is capable of controlling discarding of a data unit of a packet data convergence protocol layer more assuredly.

According to one aspect of the present invention a communication equipment (e.g., gNB-CU 110) includes a transmitting unit (data unit transmitting unit 115) that transmits a data unit of a protocol layer that handles packet data to a destination communication equipment (gNB-DU 120); a receiving unit (data unit receiving unit 117) that receives the data unit of the protocol layer from the destination communication equipment; and a control unit (control unit 119) that controls a discard timer of the data unit transmitted to the destination communication equipment. The control unit determines an amount of delay between the communication equipment and the destination communication unit, and applies a timer value corresponding to the determined amount of delay to the discard timer.

According to another aspect of the present invention a communication equipment (e.g., gNB-CU 110) includes a transmitting unit (data unit transmitting unit 115) that transmits a data unit of a protocol layer that handles packet data to a destination communication equipment; a receiving unit (data unit receiving unit 117) that receives the data unit of the protocol layer from the destination communication equipment; and a control unit (control unit 119) that controls a discard timer of the data unit transmitted to the destination communication equipment. The control unit performs a time synchronization with the destination communication equipment, and instructs the destination communication equipment to discard the data unit in accordance with termination of the discard timer.

According to still another aspect of the present invention a communication equipment (gNB-DU 120) includes a transmitting unit (data unit transmitting unit 125) that transmits a data unit of a protocol layer that handles packet data to a destination communication equipment; a receiving unit (data unit receiving unit 127) that receives the data unit of the protocol layer from the destination communication equipment; and a control unit (control unit 129) that controls a discard time of the data unit transmitted to the destination communication equipment. The control unit notifies the destination communication equipment of having discarded the data unit.

### BRIEF DESCRIPTION OF DRAWINGS

FIG. 1 is an overall schematic configuration diagram of a radio communication system 10.

FIG. 2 is a diagram showing a protocol stack of a gNB 100 and a UE 200.

FIG. 3 is a functional block diagram of a gNB-CU 110.

FIG. 4 is a functional block diagram of a gNB-DU 120.

FIG. 5 is an explanatory diagram of a relationship of an amount of delay between PDCP hosting node, a Corresponding node, and the UE 200 and a timer value applied to a discard timer of a data unit.

FIG. 6 is a diagram showing an operation flow of discarding a data unit in the PDCP layer (operation example 1).

FIG. 7 is a diagram showing an operation flow of discarding a data unit in the PDCP layer (operation example 2).

FIG. 8 is a diagram showing an operation flow of discarding a data unit in the PDCP layer (operation example 3).

FIG. 9 is a diagram showing an example of a hardware configuration of the gNB-CU 110 and the gNB-DU 120.

### MODES FOR CARRYING OUT THE INVENTION

An exemplary embodiment of the present invention will be explained below with reference to the accompanying drawings. Note that, the same or similar reference numerals have been assigned to the same functions and configurations, and the description thereof is appropriately omitted.

(1) Overall Schematic Configuration of Radio Communication System

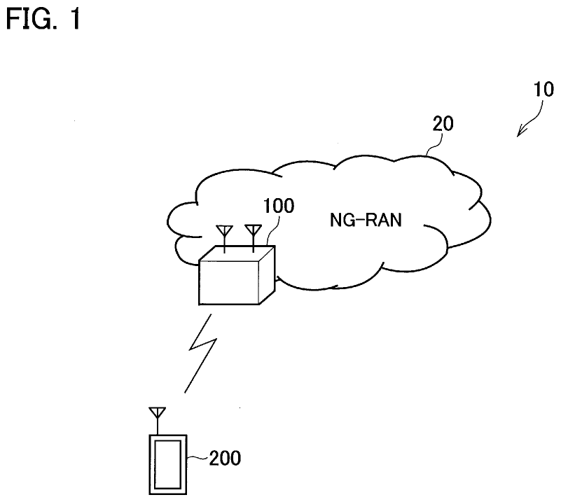

FIG. 1 is an overall schematic configuration diagram of a radio communication system 10 according to the present embodiment. The radio communication system 10 is a radio communication system according to 5G (NR).

The radio communication system 10, as shown in FIG. 1, includes Next Generation-Radio Access Network 20 (hereinafter, “NG-RAN 20”) anduser equipment 200 (hereinafter, “UE 200”). The NG-RAN 20 includes a radio base station 100 (hereinafter, “gNB 100”). A concrete configuration of the radio communication system 10, including the number of the gNBs and the UEs, is not limited to the example shown in FIG. 1.

The NG-RAN 20 practically includes a plurality of NG-RN Nodes, specifically, gNBs (or ng-eNBs), and is connected to a core network (5GC, not shown in the diagram) according to 5G.

The gNB 100 is a radio base station according to the 5G. The gNB 100 performs a radio communication with the UE 200 (and UE 200B, the same applies hereinafter) according to the 5G. In the present embodiment, the gNB 100, as described later, is constituted by Central Unit (gNB-CU) and Distributed Unit (gNB-DU).

The gNB 100 and the UE 200 can handle, by controlling a radio signal transmitted from a plurality of antenna elements, Massive MIMO that generates a beam with a higher directivity, carrier aggregation (CA) that uses a plurality of component carriers (CC), dual connectivity (DC) in which a component carrier is transmitted simultaneously between a plurality of NG-RAN Nodes and the UE, and the like.

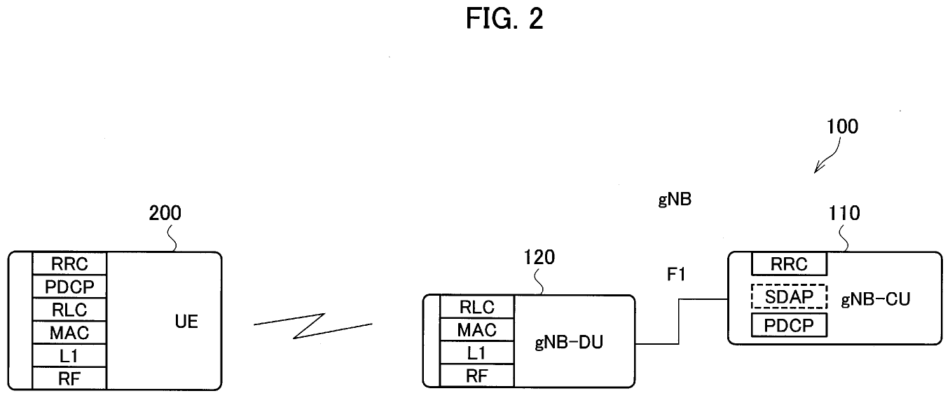

FIG. 2 shows a protocol stack of the gNB 100 and the UE 200. As shown in FIG. 2, the gNB 100 includes a gNB-Central Unit 120 (hereinafter, gNB-CU 110) and a gNB-Distributed Unit 110 (hereinafter, gNB-DU 120).

The gNB-CU 110 is a logical node that provides a packet data convergence protocol layer (PDCP) and a radio resource control layer (RRC). Moreover, the gNB-CU 110 is capable of providing a service data adaptation protocol layer (SDAP).

The gNB-DU 120 provides (hosts) lower layers, specifically, a physical layer (L1) and a radio unit (RF), a medium access control layer (MAC) and a radio link control layer (RLC).

The gNB-DU 120 supports one ora plurality of cells . One cell is supported by only one gNB-DU. The gNB-DU 120 terminates an F1 interface with the gNB-CU 110. Such separated configuration of the CU and the DU is called as Higher Layer Split (HLS).

In the present embodiment, the gNB-CU 110 has the PDCL layer, and constitutes PDCP hosting node. Moreover, the gNB-DU 120 has a layer same as or lower than the RLC layer, and constitutes a Corresponding node.

Note that, in the present embodiment, the gNB-CU 110 can constitute a communication equipment, and the gNB-DU 120 can constitute a destination communication equipment. Moreover, the gNB-DU 120 may constitute the communication equipment and the gNB-CU 110 may constitute the destination communication equipment.

The gNB-CU 110 controls an operation of one or a plurality of gNB-DU 120. The gNB-CU 110 terminates the F1 interface with the gNB-DU 120.

Moreover, the UE 200 has layers such as an RF, an L1, a MAC, an RLC, and RDCP, and an RRC.

(2) Functional Block Configuration of Radio Communication System

A functional block configuration of the radio communication system 10 will be explained below. Specifically, a functional block configuration of the gNB-DU 120 and gNB-CU 110 will be explained here.

(2.1) gNB-CU 110

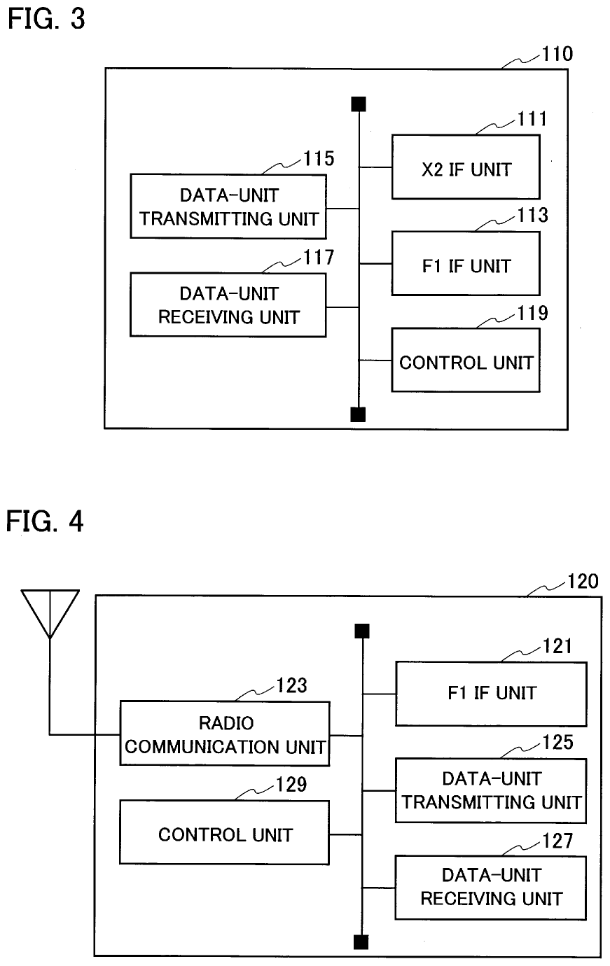

FIG. 3 is a functional block diagram of the gNB-CU 110. As shown in FIG. 3, the gNB-CU 110 includes an X2 IF unit 111, an F1 IF unit 113, a data-unit transmitting unit 115, a data-unit receiving unit 117, and a control unit 119.

The X2 IF unit 111 provides an interface for realizing communication with RAN node constituting the NG-RAN 20, such as the other gNB and the like. Specifically, the X2 IF unit 111 is an interface (X2) directly connecting to the RAN node. Various data that the UE 200 transmits is relayed to the NG-RAN 20 via the X2 IF unit 111.

The F1 IF unit 113 provides an interface for realizing communication with the gNB-CU 110 and gNB-DU 120. Specifically, the F1 IF unit 113 is an interface (Fl) directly connecting the gNB-CU 110 and the gNB-DU 120. Various data transmitted by the UE 200 is relayed to the gNB-DU 120 via the F1 IF unit 113.

The data-unit transmitting unit 115 performs processing related to transmission of data units in a plurality of layers. Specifically, the data-unit transmitting unit 15 transmits data units of protocol layers handling packet data, specifically, PDCP layers to the gNB-DU 120. Note that, the data unit here may be a Protocol Data Unit that includes a header of the layer, or may be a Service Data Unit (SDU) that does not include the header.

Moreover, the data-unit transmitting unit 115, without restricting to transmission of data units in the PDCP layer, also performs transmission of data units in other layers (SDAP and the like).

Furthermore, the data-unit transmitting unit 115 performs a so-called duplicate transmission to a plurality of destinations of data units (may be put otherwise as packets) in the PDCP layer.

The PDCP duplication has been stipulated in 3GPP TS38.323. In a case of PDCP entity set by pdcp-Duplication, a transmission-side PDCP entity can be operated as follows.

Specifically, in a case of a Signaling Radio Bearer (SRB), the data-unit transmitting unit 115 enables PDCP duplication on the basis of a control by the control unit 119 (the same applies hereinafter).

Moreover, in a case of a Data Radio Bearer (DRB) and when activation of PDCP duplication is instructed, enables PDCT duplication. Whereas, in a case in which, disabling of PDCT duplication is instructed, the data-unit transmitting unit 115 disables PDCP duplication.

Furthermore, in a case of the PDCP entity set by pdcp-Duplication, the transmission-side PDCP entity can be operated as follows. Specifically, in a case in which, it is confirmed that transmission of PDCP data PDU has succeeded, by one of two relevant AM (Acknowledgement Mode) RLC entities, the other AMRLC entity is instructed to discard a duplicated PDCP data PDU.

Whereas, in a case in which, disabling of PDCP duplication has been instructed, the data-unit transmitting unit 115 instructs a secondary RLC entity to discard all duplicated PDCP data PDU.

In the present embodiment, the data-unit transmitting unit 115 constitutes a transmitting unit that transmits a data unit of a protocol layer which handles packet data, to the destination communication equipment (gNB-DU 120).

The data-unit receiving unit 117 is a functional block that becomes a pair with the data-unit transmitting unit 115, and performs processing related to reception of data units in the plurality of layers. Specifically, the data-unit receiving unit 117 receives a data unit of the PDCP layer from the gNB-DU 120 via a lower layer.

In the present embodiment, the data-unit receiving unit 117 constitutes a receiving unit that receives a data unit of a protocol layer (PDCP) from the destination communication equipment (gNB-DU 120).

The control unit 119 controls each functional block that constitutes the gNB-CU 110. Particularly, in the present embodiment, the control unit 119 controls a discard timer of a data unit transmitted to the gNB-DU 120.

Specifically, the control unit 119 determines an amount of delay between the gNB-CU 110 (communication equipment) and the gNB-DU 120 (destination communication equipment).

More specifically, the control unit 119 acquires the amount of delay by a method such as the following, and determines the amount of delay used for control of the discard timer on the basis of the amount of delay acquired. That is, there is no matter even if the amount of delay acquired and the amount of delay determined are not identical.

Here, the amount of delay, although typically, can signify a delay time due to transmission of a data unit between the gNB-CU 110 and the gNB-DU 120, it is not necessarily restricted to such delay time. For instance, the delay time may be simply a delay time (for example, milliseconds), or may be a pair of a transmit time and a receive time, or may be a time indicating a difference from some reference time.

A specific method of acquiring the delay time will be further explained later, and measurement of delay time by health check using GPRS Tunneling Protocol (GTP) -U ECHO can be cited as an example.

The control unit 119 applies a timer value corresponding to the amount of delay determined, to the discard timer of the data unit of the PDCP layer. Specifically, the control unit 119, on the basis of a numerical value indicating the amount of delay acquired and a reference value of time set in the discard time, sets a time till the discard timer is terminated, as a timer value.

Moreover, the control unit 119 may notify a value obtained by subtracting the amount of delay from the reference value, to the gNB-DU 120 (destination communication equipment).

Specifically, the control unit 119 performs a process of time synchronization periodically so that the gNB-CU 110 and the gNB-DU 120 can be synchronized with a reference clock having an accuracy of a level same as or higher than a predetermined level (stratum). Alternatively, by using a protocol for time synchronization (Network Time Protocol (NTP) and the like) , a time to be set in the gNB-CU 110 and the gNB-DU 120 may let to be within a time difference to an extent of not causing a problem from an operation point of view.

In such manner, in a case in which the time synchronization is performed, the control unit 119, in accordance with the termination of the discard timer, instructs discarding of the data unit of the PDCP layer to the gNB-DU 120.

(2.2) gNB-DU 120

FIG. 4 is a functional block diagram of the gNB-DU 120. As shown in FIG. 4, the gNB-DU 120 includes an F1 IF unit 121, a radio communication unit 123, a data-unit transmitting unit 125, a data-unit receiving unit 127, and a control unit 129. In the following description, explanation of content similar to that for the gNB-CU 110 will be omitted appropriately.

The F1 IF unit 121, similarly as the F1 IF unit 113 of the gNB-CU 110, provides an interface for realizing communication with the gNB-CU 110 and the gNB-CU 120.

The radio communication unit 123 performs radio communication with the UE 200. Specifically, the radio communication unit 123 performs radio communication with the UE 200 in accordance with specifications of 5G. As mentioned above, the UE 200 is capable of dealing with Massive MIMO, carrier aggregation (CA), dual connectivity (DC) and the like.

The data-unit transmitting unit 125 and the data-unit receiving unit 127 are opposite to the data-unit transmitting unit 115 and the data-unit receiving unit 117 of the gNB-CU 110, and perform processing related to transmission and reception of data units in plurality of layers.

Note that, as mentioned above, in the present embodiment, the gNB-CU 110 and the gNB-DU 120 being functionally separated (refer to FIG. 2) according to HLS, the gNB-DU 120 performs processing of data units in layers same as or lower than the RLC layer.

The control unit 120 has, by and large, similar function as that of the control unit 119 of the gNB-CU 110. In a case of the gNB-DU 120, the control unit 129 may receive a reference value of time to be set in the discard timer from the gNB-CU 110, and may use a value obtained by subtracting the amount of delay from the reference value received as a timer value of the discard timer of the gNB-DU 120. Ina case in which, discarding of data unit is instructed explicitly or implicitly from the gNB-CU 110, the gNB-DU 120 may not necessarily have a discard timer.

Alternatively, the control unit 129, in a case of having discarded the data unit, may notify to the gNB-CU 110 of having discarded the data unit.

(3) Operation of Radio Communication System

Next, an operation of the radio communication system 10 will be explained below. Specifically, an operation of discarding a data unit in the PDCP layer by the gNB-CU 110 and the gNB-DU 120 will be described below.

(3.1) Relationship of Amount of Delay and Timer Value

First, a relationship of an amount of delay between the gNB-DU 120 and the UE 200 and a timer value applied to the discard timer of the data unit will be explained.

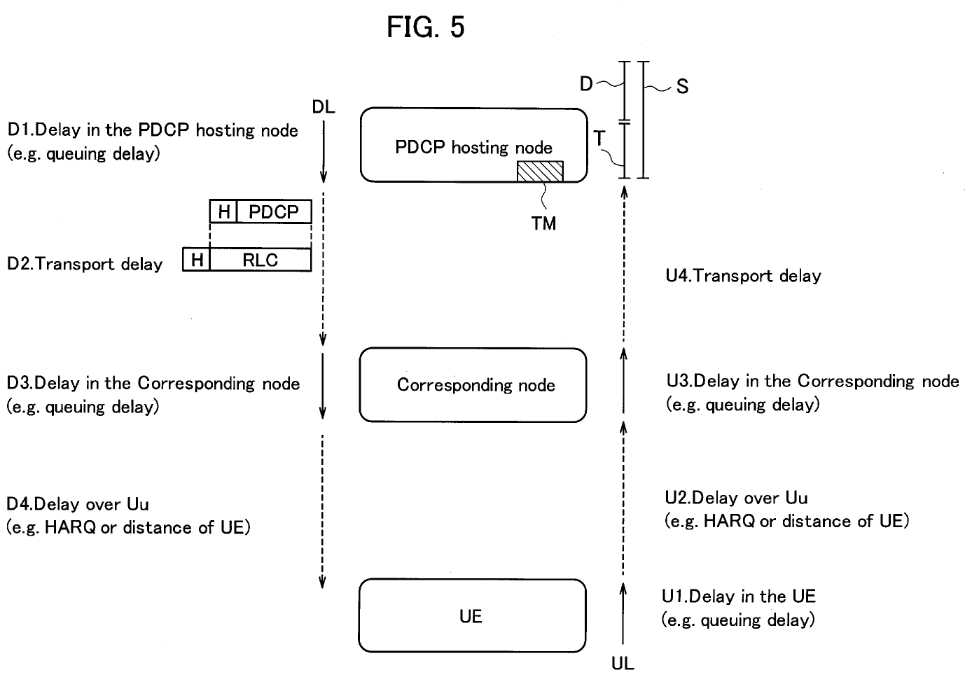

FIG. 5 is an explanatory diagram of a relationship of an amount of delay between PDCP hosting node, a Corresponding node, and the UE 200 and a timer value applied to the discard timer of the data unit.

The PDCP hosting node shown in FIG. 5, as mentioned above, is a node having PDCP entity, and the Corresponding node is a node having an entity of a layer same as or lower than the RLC.

Typically, although the gNB-CU 110 corresponds to the PDCP hosting node, and the gNB-DU 120 corresponds to the corresponding node as mentioned above, not necessarily restricted to gNB-CU and gNB-DU.

As shown in FIG. 5, in a downlink (DL) direction, the delay occurs in each section (D1 to D4 in the diagram). Specifically, in the PDCP hosting node, a delay (D1) due to queuing of data units occurs.

Moreover, in a case of the present embodiment, nodes from the PDCP hosting node to the Corresponding node are connected via the F1 interface, and due to occurrence of a constant propagation delay (D2) and equipment such as a rooter being interposed at some midpoint, the delay time may as well vary.

Furthermore, in the Corresponding node, a delay (D3) due to queuing of data units occurs. Moreover, even in a section between the Corresponding node and the UE 200 (radio section), a constant propagation delay (D4, including processing of Hybrid automatic repeat request (HARQ)) occurs.

It is, by and large, similar for an uplink direction as well, and a delay occurs in each section (U1 to U4 in the diagram).

The PDCP hosting node acquires an amount of delay D between the PDCP hosting node and the Corresponding node (a specific method of acquiring will be described later).

For making the Corresponding node discard a data unit (PDCP PDU/SDU) at an appropriate timing anticipated by the PDCP hosting node, a value obtained by subtracting the amount of delay D from a reference value S of a time set in a discard timer TM is let to be a timer value T, and the timer value T is set in the discard timer TM.

The PDCP hosting node, starts the discard timer TM on the basis of the timer value T set, and as the discard timer TM is terminated, instructs the Corresponding node to discard the corresponding node (alternatively, as mentioned above, the Corresponding node may have the discard timer TM, and discard the corresponding data unit).

(3.2) Operation Example

Next, an example of an operation of discarding a data unit will be explained below. Specifically, three operation examples (operation examples 1 to 3) will be described. The operation examples 1 to 3 explained below, basically, are intended for an operation in the downlink (DL) direction, and according to a layer configuration of the PDCP hosting node and the Corresponding node, is not necessary restricted to the DL, and may be let to be an operation in the uplink (UL) direction.

(3.2.1) Operation Example 1

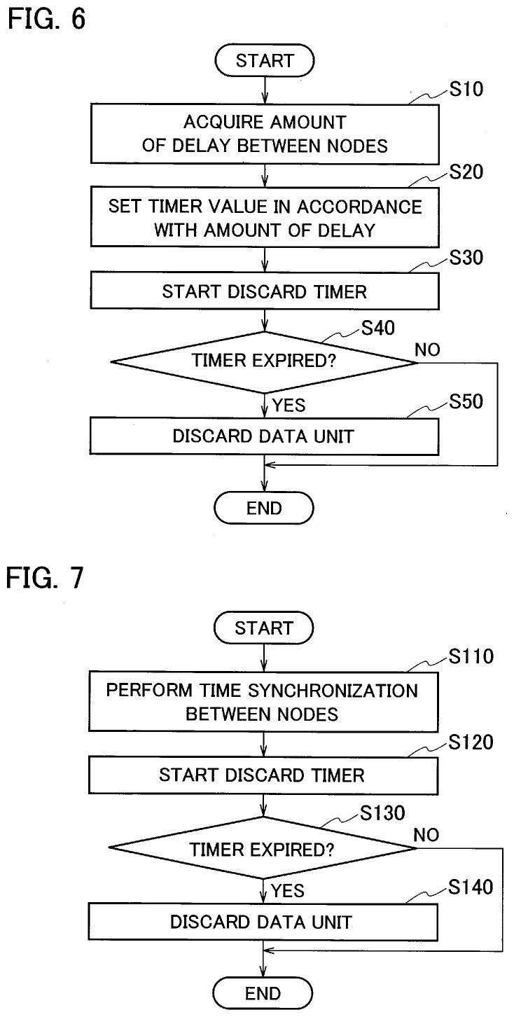

FIG. 6 shows an operation flow of discarding a data unit in the PDCP layer (operation example 1). As shown in FIG. 6, the PDCP hosting node (for example, the gNB-CU 110) acquires the amount of delay D between the nodes (between the PDCP hosting node to the Corresponding node) (Step S10).

Specifically, the PDCP hosting node acquires the amount of delay D by any of the following methods.
delay time using a GTP-U ECHO
reply from a polling according to Downlink Data Delivery Status (DDDS)
transmission and reception of the Corresponding node of a signal including a time stamp
notification of an explicit delay time from the Corresponding node

In a case of an explicit notification from the Corresponding node, the PDCP hosting node may acquire the amount of delay D repetitively, or periodically, or irregularly, and stipulate a distribution of the amount of delay or a range of the value of the amount of delay D, and determine the practical value of the amount of delay D.

Moreover, the Corresponding node may notify the amount of delay or information that resembles to this, for each variable element (for example, a buffering time, a processing time, a propagation delay or jitter of the data unit in the PDCP hosting node).

Regarding the unit of notification, the notification may be made for each packet (or data unit), for each radio bearer, RLC bearer, RLC entity, and logical channel, or may be notified in units of type (for example, data PDU, control PDU) of packet (or data unit).

More specifically, the PDCP hosting node, as explained above, may notify the timer value T obtained by subtracting the amount of delay D. Alternatively, the Corresponding node may subtract the amount of delay D from the timer value (reference value S) notified from the PDCP hosting node, and start the discard timer which the Corresponding node has.

The PDCP hosting node sets the timer value T in accordance with the amount of delay D acquired (Step S20) , and starts the discard timer TM (Step S30).

Next, the PDCP hosting node determines whether or not the time according to the timer value T set in the discard timer TM has expired (Step S40).

Ina case in which the discard timer TM is terminated, the PDCP hosting node discards the corresponding data unit (Step S50). Specifically, as explained above, the PDCP hosting node instructs discarding of data unit to the Corresponding node.

(3.2.2) Operation Example 2

FIG. 7 shows an operation flow of discarding a data unit in the PDCP layer (operation example 2). In the present operation example, time synchronization between the PDCP hosting node and the Corresponding node is performed.

As shown in FIG. 7, the PDCP hosting node and the Corresponding node perform the time synchronization between the nodes (Step S110). Specifically, each of the PDCP hosting node and the Corresponding node operate to synchronize with a highly accurate reference clock. Alternatively, the PDCP hosting node and the corresponding node may be synchronized by using a protocol for time synchronization.

In a state of the time synchronization between the nodes established in such manner, the PDCP hosting node (or the Corresponding node) starts the discard timer (Step S120). In this case, the reference value S maybe used for the timer value.

Processing at steps 5130 and step 5140 is similar to that at steps S40 and S50 in the operation example 1, but the PDCP hosting node instructs the Corresponding node to discard a data unit simply by using time (absolute time) synchronized between the nodes.

(3.2.3) Operation Example 3

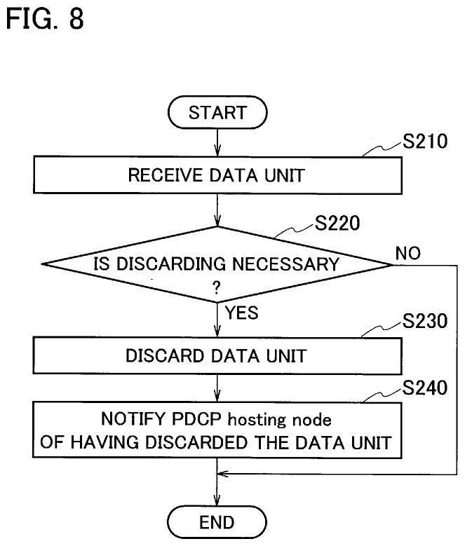

FIG. 8 shows an operation flow of discarding a data unit in the PDCP layer (operation example 3). In the present operation example, the Corresponding node that has received a data unit notifies explicitly to the PDCP hosting node that the data unit has been discarded.

As shown in FIG. 8, the Corresponding node receives a data unit transmitted by the PDCP hosting node (Step S210).

The corresponding node determines whether or not the discarding of the data unit is necessary (Step S220). Discarding separately may be based on the termination of the discard timer or may be based on some other reason.

The Corresponding node, in a case of having determined that discarding of the data unit is necessary, discards the data unit that is subjected to buffering (Step S230).

The Corresponding node notifies the PDCP hosting node of having discarded the data unit (Step S240). That is, the Corresponding node, in a case of having discarded the data unit that was subjected to buffering, notifies to the PDCP hosting node explicitly of having discarded the data unit.

However, the notification may not be explicit necessarily, and because of involvement of the other elements, the discarding may be indicated implicitly. Moreover, the Corresponding node may notify to the PDCP hosting node, information enabling to distinguish as to which data unit (or packet) was discarded.

(3.2.4) Other (Miscellaneous Items)

As mentioned above, operation examples 1 to 3 applicable to the downlink direction were explained; however, the Corresponding node, in a case in which there was an explicit instruction from the PDCP hosting node regarding discarding of data unit, may follow the instruction, or may ignore without following the instruction according to the situation.

Moreover, in a case of the uplink direction, the PDCP hosting node may discard a data unit. In this case, the PDCP hosting node is capable of operating similarly as the Corresponding node of the operation example 1 or the operation example 2 explained above.

Furthermore, the Corresponding node may notify the delay time (for example a delay in the Corresponding node, a delay between the nodes, a delay in Uu interface with the UE 200) in each delay element (such as Ul to U4 in FIG. 5, and the like).

Alternatively, the Corresponding node or the UE 200 may notify to the PDCP hosting node, information including a time stamp at the time of transmitting a data unit.

Note that, even in a case of the uplink direction, the Corresponding node may discard a data unit. In this case, it is preferable that the Corresponding node notifies to the PDCP hosting node as to which data unit (or packet) it has discarded.

(4) Advantageous Effects

According to the present embodiment explained above, the following advantageous effects are achieved. Specifically, the gNB-CU 110 (PDCP hosting node) determines the amount of delay of the gNB-CU 110 and the gNB-DU 120, and applies the timer value corresponding to the amount of delay determined, to the discard timer. Consequently, it is possible to instruct the gNB-DU 120 discarding of a data unit in the PDCP layer at an appropriate timing upon taking into consideration the amount of delay.

Accordingly, it is possible to control discarding of a data unit of the PDCP more assuredly. That is, it is possible to eliminate a situation in which a data unit that was determined to be discarded by the termination of the discard timer is practically transmitted to the UE, and a situation in which, conversely, a data unit that was determined to be transmitted is practically discarded.

When such situation arises, particularly, at the time of operation in which a manufacturer has combined the PDCP hosting node and the Corresponding node (Inter-vendor operation), there is a possibility that the operation is not normal, and according to present embodiment, it is possible to avoid such problem.

In the present embodiment, the gNB-CU 110 is capable of notifying to the gNB-DU 120, the value obtained by subtracting the amount of delay from the reference value of time set in the discard timer. Similarly, the gNB-DU 120 is capable of using the value obtained by subtracting the amount of delay from the reference value received from the gNB-CU 110 as the timer value.

Accordingly, in the gNB-DU 120, setting of the timer value in the discard timer upon taking into consideration the amount of delay is possible.

Moreover, in the present embodiment, the gNB-CU 110 and the gNB-DU 120 are capable of performing the time synchronization. Specifically, as explained above, the process of synchronizing with the reference clock having accuracy higher than a predetermined level (stratum) is performed, and using the protocol for time synchronization, the time to be set in the gNB-CU 110 and the gNB-DU 120 is let to be within the time difference to the extent of not causing a problem from the operation point of view.

Accordingly, it becomes possible to eliminate an effect of the amount of delay as mentioned above, and to control the discarding of a data unit of the PDCP more assuredly.

Furthermore, in the present embodiment, the gNB-DU 120 is capable of notifying to the gNB-CU 110 that the data unit of the PDCP has been discarded. Accordingly, the gNB-CU 110, even in a case in which there is a certain amount of delay, and is not capable of instructing the gNB-DU 120 to discard the data unit of the PDCP at an appropriate timing, the gNB-DU 120 is capable of acknowledging assuredly that the data unit of the PDCP has been discarded.

According to the control of discarding a data unit of the PDCP as explained above, it is possible to improve the efficiency such as an accuracy of the instruction to discard, and the like, including a case in which a data unit of the PDCP is subjected to duplicate transmission (PDCP duplication).

As explained above, even in the case of the uplink (UL), although not critical as in the downlink (DL), it is possible to suppress redundant data transmission and the like by discarding a data unit of the PDCP at an appropriate timing.

(5) Other Embodiments

Although the contents of the present invention have been described by way of the embodiments, it is obvious to those skilled in the art that the present invention is not limited to what is written here and that various modifications and improvements thereof are possible.

For instance, in the embodiment explained above, although the explanation was made by citing an example of the gNB-CU 110 gNB-DU 120 constituting the HLS as an example of the PDCP hosting node and the Corresponding node, the PDCP hosting node and the Corresponding node are not restricted to a combination of the gNB-CU 110 and the gNB-DU 120.

That is, in a case in which there is a certain amount of delay in the node having the PDCP entity and the node having an entity of a layer same as or lower than the RLC, and a data unit is to be discarded, it is applicable similarly.

For instance, as another example of the PDCP hosting node and the Corresponding node, at the time of dual connectivity, in a node (gNB) having PDCP entity and a node (eNB) having an entity of a layer same as or lower than the RLC, in a case in which there is a certain amount of delay, and a data unit is to be discarded, it is applicable similarly.

Moreover, in the embodiment explained above, although the explanation was made by citing an example of a data unit of PDCP, it is not necessarily restricted to PDCP, provided that it is a protocol handling packet data of IP and the like.

Moreover, the block diagram used for explaining the embodiments (FIGS. 3 and 4) shows blocks of functional unit. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that causes transmitting may be called a transmitting unit or a transmitter. For any of the above, as explained above, the realization method is not particularly limited to any one method.

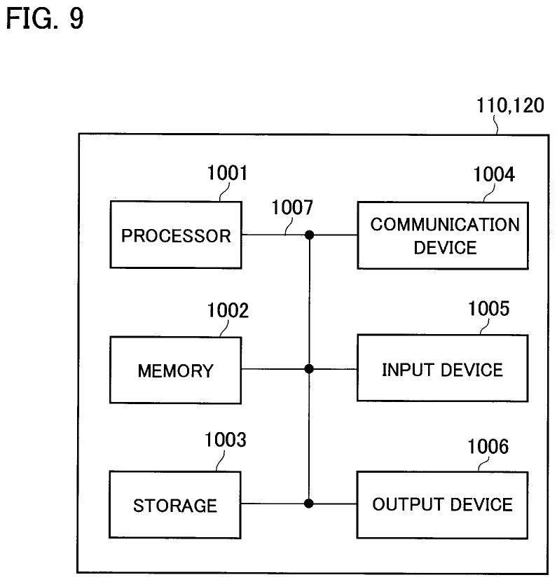

Furthermore, the gNB-CU 110 and gNB-DU 120 (reference device) explained above can function as a computer that performs the processing of the radio communication method of the present disclosure. FIG. 9 is a diagram showing an example of a hardware configuration of the reference device. As shown in FIG. 9, the reference device can be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

The functional blocks of the reference device (see FIGS. 3 and 4) can be realized by any of hardware elements of the computer device or a desired combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 can be called register, cache, main memory (main memory), and the like. The memory 1002 can store therein a computer program (computer program codes), software modules, and the like that can execute the method according to the embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information there among. The bus 1007 can be constituted by a single bus or can be constituted by separate buses between the devices.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, Downlink Control Information (DCI), Uplink Control Information (UCI), upper layer signaling (for example, RRC signaling, Medium Access Control (MAC) signaling, notification information (Master Information Block (MIB), System Information Block (SIB)), other signals, or a combination of these. The RRC signaling may be called RRC message, for example, or can be RRC Connection Setup message, RRC Connection Reconfiguration message, or the like.

Each of the above aspects/embodiments can be applied to at least one of Long Term Evolution (LTE), LTE-Advanced (LTE-A), SUPER 3G, IMT-Advanced, 4th generation mobile communication system (4G), 5^{th} generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)) , IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

As long as there is no inconsistency, the order of processing procedures, sequences, flowcharts, and the like of each of the above aspects/embodiments in the present disclosure may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of a channel and a symbol may be a signal (signaling). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Likewise, a mobile station in the present disclosure may be read as a base station. In this case, the base station may have the function of the mobile station.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 Radio communication system
20 NG-RAN
100 gNB
110 gNB-CU
111 X2 IF unit
113 F1 IF unit
115 Data unit transmitting unit
117 Data unit receiving unit
119 Control unit
120 gNB-DU
121 F1 IF unit
123 Radio communication unit
125 Data unit transmitting unit
127 Data unit receiving unit
129 Control unit
200 UE
D Amount of delay
S Reference value
T Timer value
1001 Processor
1002 Memory
1003 Storage
1004 Communication device
1005 Input device
1006 Output device
1007 Bus

1. A communication equipment comprising:
a transmitting unit that transmits a data unit of a protocol layer that handles packet data to a destination communication equipment;
a receiving unit that receives the data unit of the protocol layer from the destination communication equipment; and
a control unit that controls a discard timer of the data unit transmitted to the destination communication equipment, wherein
the control unit
determines an amount of delay between the communication equipment and the destination communication unit, and
applies a timer value corresponding to the determined amount of delay to the discard timer.

2. The communication equipment as claimed in claim 1, wherein the control unit notifies to the destination communication equipment a value obtained by subtracting the amount of delay from a reference value.

3. The communication equipment as claimed in claim 1, wherein the control unit uses as the timer value a value obtained by subtracting the amount of delay from a reference value received from the destination communication equipment.

4. A communication equipment comprising:
a transmitting unit that transmits a data unit of a protocol layer that handles packet data to a destination communication equipment;
a receiving unit that receives the data unit of the protocol layer from the destination communication equipment; and
a control unit that controls a discard timer of the data unit transmitted to the destination communication equipment, wherein
the control unit
performs a time synchronization with the destination communication equipment, and
instructs the destination communication equipment to discard the data unit in accordance with termination of the discard timer.

5. A communication equipment comprising:
a transmitting unit that transmits a data unit of a protocol layer that handles packet data to a destination communication equipment;
a receiving unit that receives the data unit of the protocol layer from the destination communication equipment; and
a control unit that controls a discard time of the data unit transmitted to the destination communication equipment, wherein
the control unit notifies the destination communication equipment of having discarded the data unit.
